(19) United States
(12) Patent Application Publication
(10) Pub. No.: US 2013/0237281 A1
(43) Pub. Date: Sep. 12, 2013

(54) Communication Methods and Devices for the Infirm

(71) Applicant: CONCERO, LLC, Harrisonburg, VA (US)

(72) Inventors: Kent A. MURPHY, Troutville, VA (US); Philip R. COUCH, Cotleigh Honiton (GB); Michael F. GUNTHER, Blacksburg, VA (US); Charles B. GAUSE, Providence, NC (US)

(73) Assignee: CONCERO, LLC, Harrisonburg, VA (US)

(21) Appl. No.: 13/786,617

(22) Filed: Mar. 6, 2013

Related U.S. Application Data
(60) Provisional application No. 61/607,022, filed on Mar. 6, 2012.
(60) Provisional application No. 61/609,447, filed on Mar. 12, 2012.

(51) Int. Cl. H04M 1/02

(52) U.S. Cl. CPC H04M 1/026
USPC 455/556.1; 455/575.1; 455/566

(57) ABSTRACT

The telephone handset for the infirm includes a housing, wherein the housing has the appearance of an old-style telephone handset, internal electronics including a microphone, a speaker, wireless communication circuitry, and signal processing circuitry for processing signals received by the wireless communications circuitry to drive the speaker and for processing signals received from the microphone to transmit a signal representative of the received microphone signal wireless to one or more remote audio communication devices. The telephone handset also includes a simplified user interface which includes a predetermined number of keys less than ten, where the keys are programmed to cause the internal electronics to initiate contact with at least one specific remote audio communication device upon actuation. The telephone handset also has a multifunction user interface with at least a full numeric keypad and other keys sufficient to program the keys of the simplified user interface.

### CROSS-REFERENCE TO RELATED APPLICATIONS

This application claims benefit of U.S. Provisional Application No. 61/607,022 filed on Mar. 6, 2012 and U.S. Provisional Application No. 61/609,447 filed on Mar. 12, 2012, herein incorporated by reference.

### FIELD

The present telephone handset includes a housing with the appearance of an old-style handset that includes internal electronics, a simplified interface, and a multifunction interface.

### BACKGROUND

Conventional cellular telephones are increasingly taking a variety of shapes not traditionally associated with telephone devices. This can cause confusion for individuals, particularly those suffering from age related loss of faculties, who previously used and were familiar with telephone handsets of an earlier design.

There exist a general shape that is largely universally recognized as representing a telephone type device. One example of such a device is the Western Electric Model 500 telephone handset that was manufactured for over 30 years. Millions of these devices were sold and many remain in use today. The pervasiveness of this and similarly shaped devices have caused the shape and silhouette of such telephones to represent a particular function to the general population. For example, pay phone stalls typically have imagery that shows the silhouette of a telephone handset that resembles the Western Electric Model 500 telephone handset. Many software packages that allow individuals to communicate with others use similar icons. Smartphone devices like the Apple iPhone also include a similar icon to represent the activation of the telephone functionality of the device. Thus, a device with a similar shape and silhouette will cause individuals to immediately understand that the device is usable as a telephone type device.

Additionally, individuals with limited physical and mental capabilities may have difficulty and even be unable to operate a conventional telephone device. These individuals nonetheless have a desire and/or need to communicate with others, and in particular with loved ones and caregivers. Family members, loved ones, and caregivers also have a desire to be able to communicate with these individuals and ensure their wellbeing. As the population ages, the number of these individuals will tend to increase.

Furthermore, a limited number of phone numbers are called with any frequency by individuals with limited physical and mental capabilities, or are of sufficient importance that they should always be easily accessible to these individuals.

Accordingly, it would be desirable to have a telephone handset that addresses these and other needs, particularly for individuals with limited physical and mental capabilities.

### SUMMARY

It would be advantageous to include a way to associate keys of a simplified interface with desired phone numbers so that the dialing process can be simplified. The use of imagery may help simplify an interface even further. Both regular and impeded individuals can benefit from the simplified interface and easily operate the simplified interface and dial desired phone numbers.

The telephone handset for the infirm includes a housing, wherein the housing has the appearance of an old-style telephone handset, internal electronics including a microphone, a speaker, wireless communication circuitry, and signal processing circuitry for processing signals received by the wireless communications circuitry to drive the speaker and for processing signals received from the microphone to transmit a signal representative of the received microphone signal wireless to one or more remote audio communication devices. The telephone handset also includes a simplified user interface which includes a predetermined number of keys less than ten, where the keys are programmed to cause the internal electronics to initiate contact with at least one specific remote audio communication device upon actuation. The telephone handset also has a multifunction user interface with at least a full numeric keypad and other keys sufficient to program the keys of the simplified user interface.

The telephone handset for the infirm may be included in a telephone system. The telephone system includes the telephone handset with a housing, internal electronics, a simplified user interface, and a multifunction user interface. The telephone system also includes a base station that includes a multifunction user interface, a speaker, a microphone, and a camera, where the multifunction user interface has at least a full numeric keypad and other keys sufficient to program the keys of the simplified user interface of the telephone handset.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

The telephone handset and system will now be described by way of exemplary embodiments to which it is not limited by reference to the accompanying drawings, in which:

FIG. 1 illustrates one embodiment of the telephone handset with a simplified interface.

FIG. 2 illustrates another view of the embodiment of the telephone handset shown in FIG. 1.

FIG. 3 illustrates the internal electronics of an embodiment of the telephone handset.

FIG. 4 illustrates a rear view of the embodiment of the telephone handset shown in FIG. 1.

FIG. 5 illustrates one embodiment of the telephone handset and the base station.

### DETAILED DESCRIPTION

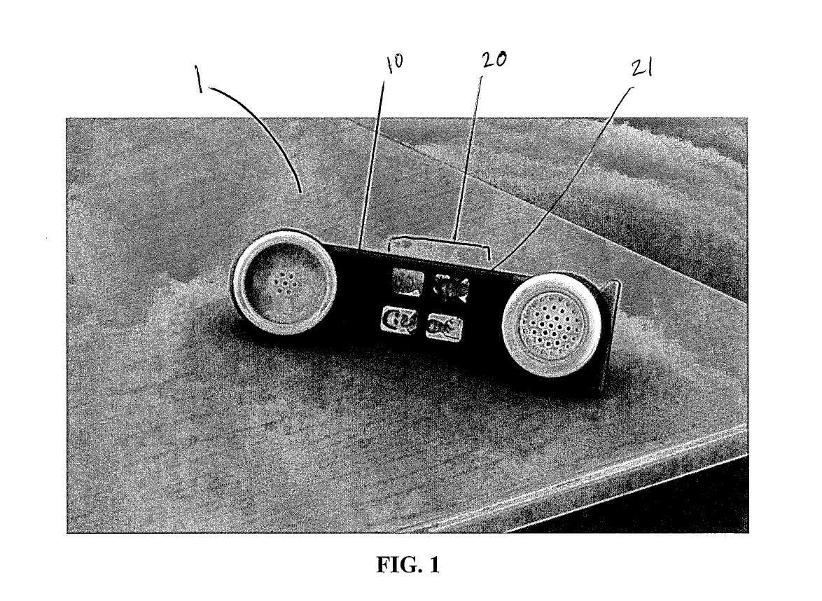

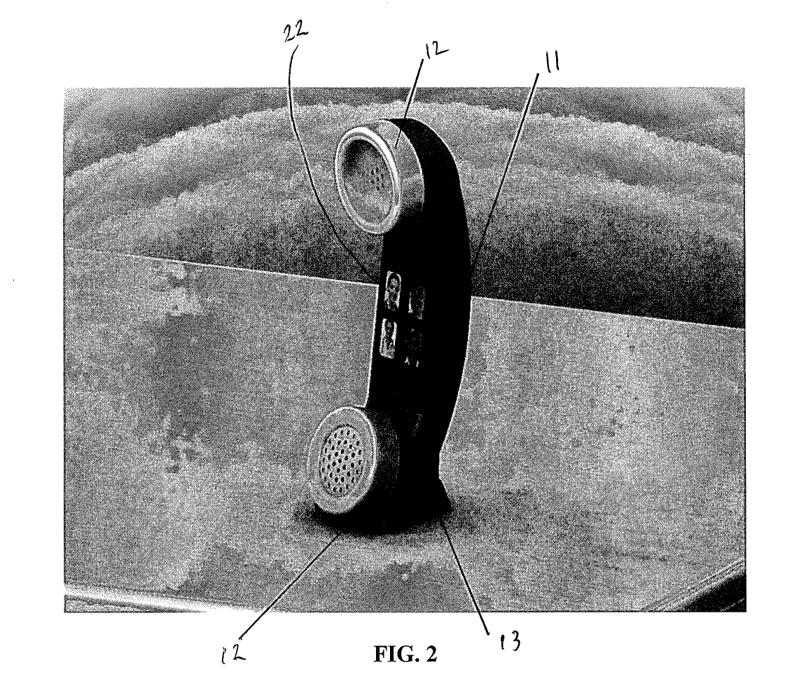

FIG. 1 illustrates one exemplary embodiment of a telephone handset 1 with a housing 10 styled with the appearance of an old-style telephone handset. The handset 1 as shown in FIG. 2 has an oblong central section 11 that has a curved axis. The oblong central section 11 is sufficiently long to permit an average person to easily grasp. The oblong central section 11 connects two substantially similar disc-shaped end sections 12. The disc-shaped end sections 12 resemble the ends of an old-style telephone handset and may include a plurality of apertures that allow for the passage of sound with minimal distortion. Each of the disc-shaped end sections 12 may include differing numbers of apertures or detents that visually simulate apertures, and at least one of the disc-shaped end sections 12 may include no apertures, but generally resemble apertures that had been needed for old-style audio transducers (speaker and microphone). The housing 10 in FIG. 1 may include apertures at a location other than the disc-shaped end sections 12 that also allow for the passage of sound with minimal distortion. For example, the ear-piece side of the housing 10 can have apertures for micro-electrical-mechanical (MEMs) based transducers around the periphery of one of the discs of the end sections 12 such that the sound is omnidirectional and acts as a speakerphone, so that if the user holds the telephone away from their ear, or even upside-down, the user can still hear the speaker on the other side of the line.

The housing 10 may include a base portion 13 at one end of the handset that helps allow the handset to sit on a surface in a manner that allows for hands-free operation of the device. In one embodiment, as shown in FIG. 2, the base portion causes the curved axis of the oblong central section 11 to be more vertical than horizontal. The housing 10 may also include an attachment portion adapted for a lanyard or other device to ensure the telephone handset is easily accessible for the user. The attachment portion of the housing 10 may be structurally reinforced so that any additional stresses on the housing due to the use of a lanyard or other device do not compromise the housing 10 of the telephone device 1.

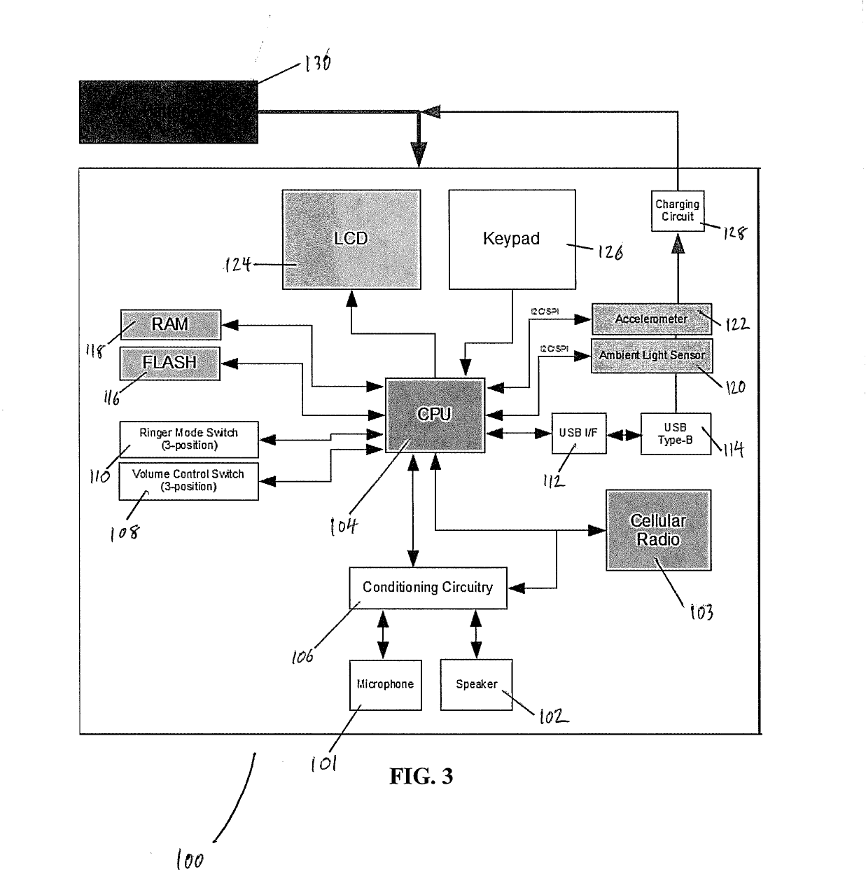

The housing 10 of the telephone handset 1 encloses internal electronics 100 that perform the various functions of the phone. The internal electronics 100 include a central processing unit 104 that is connected to a microphone 101, a speaker 102, and a wireless communication module 103 (enabled to communicate using one or more of cellular, WiFi, BlueTooth, ZigBee, etc. protocols), among other features. The internal electronics 100 shown in FIG. 3 are powered by a battery 130. The battery 130 may be recharged when the telephone handset 1 is connected to a power source through a wired connection such as power line, a Universal Serial Bus (USB) connection, or a wireless connection like an inductive charger. In an alternate embodiment, the internal electronics 100 may also include an on/off switch. The on/off switch deactivates the phone and helps reduce the possibility of unintentional activation of the phone in situations where the privacy of the individuals speaking near the handset is paramount. For example, when the user is speaking with his or her doctor, the user, or in some circumstances, the doctor may actuate the on/off switch so that the phone is deactivated and the privacy of the user can be ensured.

The central processing unit 104 executes programs stored in memory 116, which can be flash memory or any suitable non-volatile memory. The central processing unit 104 receives inputs from the keypad 126, the microphone 101, the accelerometer 122, the ambient light sensor 120, the ringer mode switch 110, the volume control switch 108, and a USB interface, among others. The central processing unit 104 provides output by using the LCD 124, the lighting of the keypad 126, and the speaker 102, among others. The central processing unit 104 also enables a remote device to monitor the inputs or readings from the different components of the telephone handset 1 and to execute various functions with the components of the internal electronics 100 of the telephone handset 1. In an alternate embodiment, a camera that is optionally configured to capture panoramic images is included in the internal electronics 100 and may be remotely activated by a smartphone or other communication device to view the surrounding area of the telephone handset 1.

A telephone handset 1 of the embodiment shown in FIG. 1 includes a simplified interface 20. The simplified interface 20 has fewer keys than a conventional numeric keypad that has at least ten keys, such as six or four physical buttons 21 with imagery associated with the respective keys. The four keys 21 are associated with pre-programmed numbers so that when pressed, the associated number is automatically dialed.

The simplified interface 20 is illustrated as positioned on the oblong central section 11 of the housing 10. The simplified interface 20 may be arranged on any portion of the handset 1 that is appropriate and is not limited to the positioning depicted in the included figures.

As stated above, each of the buttons 21 of the simplified interface 20 is programmed to activate a particular function. One such function is to dial the telephone number of a family member. Another function is to dial the telephone number of a caregiver or other service provider. A further function is to initiate contact with a remote audio communication device using a particular communications network. The functions programmed for each button 21 may include multiple aspects. One example is for the button to activate a function that plays prerecorded audio before dialing the telephone number of a particular family member. This helps improve the usability of the telephone handset by providing the user an audio message that corresponds to the actuated button 21 and confirms to the user the correct function is being executed. In fact, if the initiated communication path is not completed, an automated message may be played. For example, activation of a key might result in “Mom, thanks for calling me” and if the connection is not completed, “I can't pick up the telephone right now, but please leave me a message at the beep and I will call back as soon as I can” or the like. The functions activated by each of the buttons 21 of the simplified interface 20 may also perform aspects that are not associated with connecting to a remote audio communication device. For example, one of the buttons 21 of the simplified interface 20 may cause the telephone handset 1 to play prerecorded audio that indicates who the main user of the telephone handset 1 is. This function is particularly useful in situations where a plurality of telephone handsets 1 may exist in the same area, leading to confusion as to whom each telephone handset 1 belongs.

The imagery of the physical buttons 21 corresponds to the function of the particular button. The imagery may be affixed to the button 21 or may be an integral part of the physical button 21. The imagery helps a user to easily and intuitively understand the function associated with the button even when the user has reduced or limited mental abilities. A further embodiment may use physical buttons that each include screens that are easily reprogrammable to display the desired imagery. A still further embodiment may use a touch screen with areas that when activated execute a particular function. The touch screen may display imagery in the areas that when activated execute a particular function so that the function associated with the area can be easily and intuitively understood by the user.

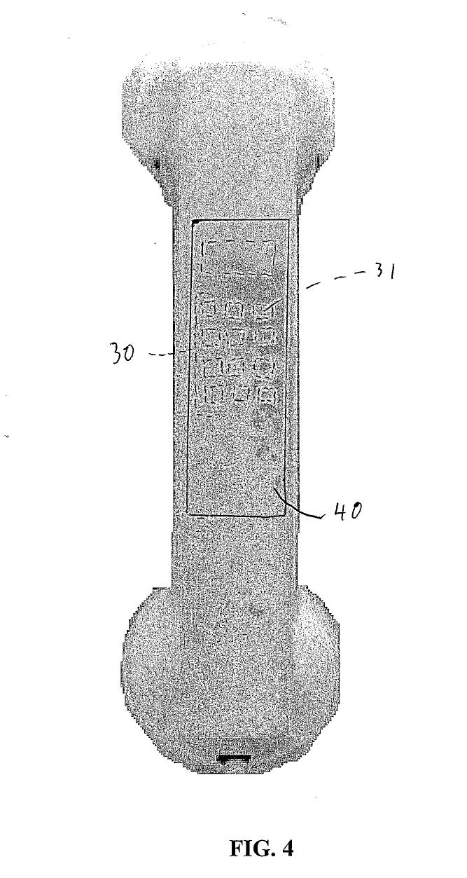

A multifunction user interface 30 may be included on the telephone handset 1. In an embodiment depicted in FIG. 4, the multifunction user interface 30 is located on the rear surface of the oblong central portion 11 of the housing 10. The multifunction user interface 30 may be positioned on any portion of the handset 1 that is appropriate and is not limited to the positioning illustrated in the included Figures. The multifunction user interface 30 has a full numeric keypad and other multifunction keys 31. The multifunction user interface 30 programs the keys 21 of the simplified interface 20 and assigns the particular functions that are executed when the keys 21 of the simplified interface 20 are activated. The multifunction user interface 30 may include a display for facilitating the programming of the keys 21 of the simplified interface 20. The multifunction user interface 30 causes the internal electronics 100 to change the functions that are executed when the buttons 21 of the simplified interface 20 are activated by the user. In an alternate embodiment, the multifunction user interface 30 also assigns the imagery displayed on each of the buttons 21 of the simplified interface 20.

The multifunction user interface 30 may be covered by an access cover 40. The access cover 40 may be secured and require the use of a separate unsecuring device (such as a paperclip) to allow access to the multifunction user interface 30. In one embodiment, a paper clip is used to unsecure the access door 40. In an alternate embodiment, a small coin or other unsecuring device may be used to unsecure the access door. The access cover 40 may be transparent, translucent, or opaque so as to obscure the components underneath.

In an alternate embodiment, the simplified interface 20 may be programmed by a separate control device. The separate control device may be connected to the telephone handset 1 by a wired or a wireless connection. The separate control device may use a USB, Thunderbolt, FireWire, Ethernet, or another common wired interface. The separate control device may use a Bluetooth, WiFi (IEEE 802.11), Zigbee, inductive, or other common wireless interface. The separate device may include a multifunction user interface that can assign the particular functions that are executed when the keys 21 of the simplified interface 20 are activated. The multifunction user interface of the separate control device may also assign the imagery displayed on each of the buttons 21 of the simplified interface. The separate control device may also control other aspects of the telephone handset 1 including the ringer mode and the volume.

The separate control device may also monitor the inputs or readings from the different components of the telephone handset 1 and execute various functions with the components of the internal electronics 100 of the telephone handset 1. In one embodiment, the separate control device may be used to monitor the ambient light sensor 120 to determine if the user of the telephone handset 1 has turned on a light in the room. In another embodiment, the separate control device may be used to monitor the accelerometer 122 to determine if the handset 1 has abruptly changed from a substantially vertical orientation to a substantially horizontal orientation. In response, the separate control device may remotely activate the microphone 101 and the speaker 102 so that communication may be established with the user of the telephone handset 1 so that the condition of the user may be ascertained. In a further embodiment, the separate control device may remotely activate the camera so that the condition of the user may be ascertained.

The telephone handset 1 may be programmed to respond in a predetermined manner depending on which remote audio communication device is attempting to page the user of the telephone handset 1. One example of a predetermined response is automatically answering the page from the remote audio communication device after a set number of rings. This predetermined response allows the user of the telephone handset 1 to easily and automatically respond to pages from a particular remote audio communication device without user intervention. Another example of a predetermined response is to play prerecorded audio that corresponds to the remote audio communication device that is paging the telephone handset. The prerecorded audio may announce to the user of the telephone handset 1 who is attempting to contact the user. This predetermined response allows the user of the telephone handset 1 to determine who is attempting to contact the user without requiring any intervention by the user. The predetermined response may also include a visual indication of who is attempting to contact the user. For example, if the person attempting to contact the user of the telephone handset 1 is associated with one of the keys 21 of the simplified interface 20, the key 21 may be illuminated in a distinctive fashion so that the user can immediately understand who is attempting to contact the user. A further example of a predetermined response is to require user intervention to respond to pages from remote audio communication devices. One example of such a predetermined response requires that the user press one of the simplified interface keys 21 to respond to the page from the remote audio communication device. Another example of such a predetermined response requires the user to press a particular sequence of keys 21 of the simplified interface 20 to respond to the page from the remote audio communication device. The predetermined responses may be programmed by the multifunction interface 30 or may be programmed by a separate control device connected by a wired or wireless connection. Other predetermined responses may be configured to improve the usability of the telephone handset 1.

The telephone handset 1 may also be programmed to respond in a predetermined manner when the remote audio communication device that corresponds to the actuated key does not respond to the request to initiate contact. In one embodiment, after the remote audio communication device has not responded to the request to initiate contact for a predetermined period of time, the telephone handset 1 plays prerecorded audio that corresponds to the remote audio communication device that did not respond. One example of such prerecorded audio may indicate to the user that the person to whom the remote audio communication device is associated with is currently not available but will return the call as soon as the person returns to the remote audio communication device. This improves the usability of the telephone handset 1 by providing information to the user when the person associated with the remote audio communication device does not respond.

The telephone handset 1 may be operated as a speaker phone where the handset 1 may be placed on a surface that is not adjacent to the user's head. The telephone handset 1 may also be operated like conventional telephone device that is placed adjacent to the user's head. The speaker 102 of the telephone handset 1 may be configured so that the volume will not damage the user's hearing or cause discomfort when the telephone handset 1 is operated adjacent to the user's head.

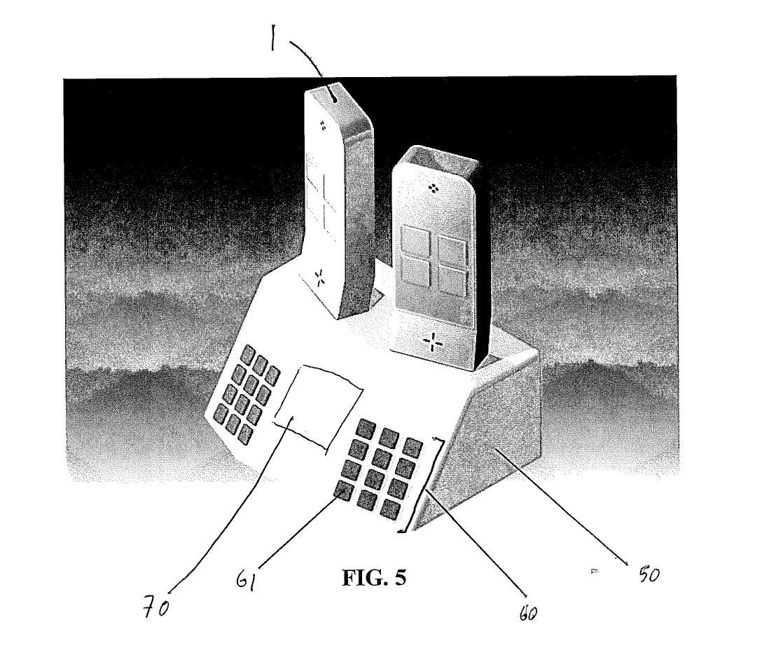

The telephone handset 1 may also be part of a telephone system. The telephone system includes the telephone handset 1 and also a base station 50. One embodiment of the base station 50 is illustrated in FIG. 5. The base station 50 accepts at least one telephone handset and secures the handset in an upright manner so that the plane defined by the two substantially similar disc-shaped end sections 12 is substantially perpendicular to the horizontal surface on which the base station 50 rests. In an alternative embodiment, the base station 50 accepts two or more telephone handsets 1 and secures the handsets 1 in an upright manner so that the planes defined by the two substantially similar disc-shaped end sections 12 are substantially perpendicular to the horizontal surface on which the base station 50 rests.

The base station 50 is adapted to both secure the handsets in an upright manner and also to recharge the telephone handsets 1. The base station 50 may recharge the telephone handsets 1 through inductive charging or through a standard electrical connection. The base station 50 also includes a multifunction interface 60 for each of the telephone handsets 1 Like the multifunction user interface 30 of the telephone handset 1, the multifunction interface 60 may be used to program the corresponding telephone handset 1 and assign the particular functions that are executed when the keys 21 of the simplified interface 20 are activated.

The base station 50 may also include a speaker and a microphone. The speaker and the microphone of the base station 50 allows the base station 50 transmit and receive audio to and from the remote audio communication device even if the speaker 102 and the microphone 101 of the telephone handset 1 are partially or completely obstructed by the base station 50 when the telephone handset 1 is secured to the base station 50. The base station 50 may also include a camera optionally configured to capture panoramic images and a display device 70 for displaying imagery. The multifunction interface 60 of the base station 50 may be used to assign the imagery displayed on the display device 70 of the base station 50. The base station 50 also includes internal electronics that allow the inputs or the readings from the different components of the base station 50 to be monitored remotely and that also allow the components of the internal electronics of the base station 50 to execute various functions. The base station 50 may be controlled by a separate control device connected by a wired or wireless connection.

The telephone system may include a separate central control device. The separate central control device is similar to the separate control device but is also configured to control multiple telephone handsets 1 and multiple base stations 50. The separate central control device connects to multiple telephone handsets 1 and multiple base stations 50 by way of a wired or a wireless interface. The separate central control device may monitor the inputs or readings from the different components of the multiple telephone handsets 1 and execute various functions with the components of the internal electronics 100 of the multiple telephone handsets 1. The separate central control device may also monitor the inputs or readings from the different components of multiple base stations 50 and execute various functions with the components of the internal electronics of the multiple base stations. In an alternate embodiment, the separate central control device may assign the imagery displayed on the display device 70 of the base station 50.

In one embodiment, the separate central control device may be used to monitor the accelerometers 122 of multiple telephone handsets 1. For example, when the accelerometer 122 of a particular telephone handset 1 indicates that the handset 1 has abruptly changed from a substantially vertical orientation to a substantially horizontal orientation, the separate central control device may remotely activate the microphone 101 and the speaker 102 of the telephone handset 1 so that communication may be established with the user of the telephone handset so that the user's condition may be ascertained. The separate central control device may also remotely activate the microphone and the speaker of the base station 50 to ascertain the user's condition also. The separate central control device may also act as a remote audio communication device so that the user of the telephone handset 1 and the base station 50 may communicate with an individual operating the separate central control device.

It will be understood that the foregoing description is of the preferred embodiments, and is, therefore, merely representative of the article. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

What is claimed:

1. A telephone handset, comprising:
a housing, wherein the said housing has the appearance of an old-style telephone handset;
internal electronics including a microphone, a speaker, wireless communication circuitry, and signal processing circuitry for processing signals received by the wireless communications circuitry to drive the speaker and for processing signals received from the microphone to transmit a signal representative of the received microphone signal wirelessly to one of more remote audio communication devices;
a simplified user interface, wherein the simplified user interface has a predetermined number of keys less than ten, said keys being programmed to cause said internal electronics to initiate contact with at least one specific remote audio communication device upon actuation; and
a multifunction user interface, said multifunction user interface having at least a full numeric keypad and other keys sufficient to program said keys of said simplified user interface.

2. The telephone handset of claim 1, wherein said handset has an oblong central section having a curved axis of sufficient length to permit an average human hand to grasp the central section, two substantially similar disc-shaped end sections each defining a plane parallel to a most proximate portion of the curved axis of the central section; and
wherein said planes intersect defining a line perpendicular to a plane in which the curved axis exists, with a transition portion between the central section and the disc-shaped portion.

3. The telephone handset of claim 2, wherein the housing further comprising a base portion on one end of the handset to permit the handset to sit on a surface where in the curved axis of the central portion is more vertical than horizontal.

4. The telephone handset of claim 1, wherein the speaker includes at least one omnidirectional speaker adjacent to a plurality of apertures positioned near one of end of the handset, and said microphone is adjacent at least on aperture near the other end of said handset.

5. The telephone handset of claim 1, wherein the simplified user interface has less than six keys, each key having an associated image of a person or service.

6. The telephone handset of claim 5, where in the images of the simplified user interface are on paper, and said paper is positioned on top of a pressure actuated switch.

7. The telephone handset of claim 5, wherein the simplified user interface is a touch-screen interface on which less than six areas are defined and each area displays an image of a person or service.

8. The telephone handset of claim 1, wherein the internal electronics automatically answers a page from a remote audio communication device after a preset number of rings.

9. The telephone handset of claim 8, wherein only pages from certain remote audio communication devices are automatically answered.

10. The telephone handset of claim 1, an access cover to cover said multifunction user interface, the access cover configured to be unsecured with a separate unsecuring device.

11. The telephone handset of claim 1, further comprising a camera and at least one accelerometer.

12. The telephone handset of claim 11, wherein the camera is capable of panoramic imaging; and wherein both the camera and the accelerometer can be remotely activated and monitored.

13. The telephone handset of claim 1, wherein the internal electronics can be programmed by a control device connected to the telephone handset by a wireless or a wired interface.

14. The telephone handset of claim 1, wherein when the remote audio communication device corresponding to the actuated key does not respond to a request to initiate contact from the telephone handset after a predetermined period of time, a prerecorded message that corresponds to the actuated key is played through the speaker.

15. A telephone system, comprising:
a handset comprising:
a housing, wherein the said housing has the appearance of an old-style telephone handset;
internal electronics including a microphone, speaker, wireless communication circuitry and signal processing circuitry for processing signals received by the wireless communications circuitry to drive the speaker and for processing signals received from the microphone to transmit a signal representative of the received microphone signal wirelessly to one or more remote audio communication devices; and
a simplified user interface, wherein the simplified user interface has a predetermined number of keys less than ten, said keys being programmed to cause said internal electronics to initiate contact with at least one specific remote audio communication device upon actuation;
the handset having an oblong central section with a curved axis and long enough to permit an average human hand to grasp the central section, two substantially similar disc-shaped end sections each defining a plane parallel to a most proximate portion of the curved axis of the central section and wherein said planes intersect defining a line perpendicular to a plane in which the curved axis exists, with a transition portion between the central section and the disc-shaped portion; and
a base-station comprising a multifunction user interface, a speaker, a microphone, and a camera, said multifunction user interface having at least a full numeric keypad and other keys sufficient to program said keys of said simplified user interface of the handset.

16. The telephone system of claim 15, wherein
the base station secures the handset in an upright manner so that the plane defined by the two substantially similar disc-shaped end sections is substantially perpendicular to a horizontal plane on which the base station is placed.

17. The telephone system of claim 15, wherein
the base station secures the handset in a horizontal manner so that the plane defined by the two substantially similar disc-shaped end sections is substantially parallel to a horizontal plane on which the base station is placed.

18. The telephone system of claim 15, wherein the base station camera, the base station speaker, and the base station microphone can be remotely activated and remotely monitored; and
wherein the base station further includes a display device that can be remotely activated to display content from a remote source.

19. The telephone system of claim 15, further comprising:
a control device capable of connecting to at least one handset or base station by a wireless or a wired interface;
wherein when the control device is connected to a handset, the control device is configured to program the keys of the simplified user interface of the handset and the control device is configured to remotely activate and monitor at least one of the speaker, the microphone, and the camera; and
wherein when the control device is connected to a base station, the control device is configured to remotely activate and monitor at least one of the speaker, the microphone, and the camera.
